(19) United States
(12) Patent Application Publication
(10) Pub. No.: US 2021/0149194 A1
(43) Pub. Date: May 20, 2021

(54) DISPLAY APPARATUS AND DISPLAY CONTROL METHOD

(71) Applicant: SAMSUNG ELECTRONICS CO., LTD., Suwon-si (KR)

(72) Inventors: Daesu CHOI, Suwon-si (KR); Jigwang Kim, Suwon-si (KR); Jiwon Kim, Suwon-si (KR); Jaemin Soh, Suwon-si (KR); Kyehoon Lee, Suwon-si (KR); Sanghoon Lee, Suwon-si (KR)

(73) Assignee: SAMSUNG ELECTRONICS CO., LTD., Suwon-si (KR)

(21) Appl. No.: 17/094,424

(22) Filed: Nov. 10, 2020

(30) Foreign Application Priority Data
Nov. 18, 2019 (KR) 10-2019-0148084

(51) Int. Cl. G02B 27/01; G09G 5/10

(52) U.S. Cl. CPC G02B 27/0101; G09G 5/10; G02B 2027/0154; G09G 2360/144; G02B 2027/014; G02B 27/0149

(57) ABSTRACT

A display apparatus and a display control method. The display apparatus includes an image source configured to output an image; a relay optics component configured to change a size of the image and to transfer the image; a combiner configured to form a virtual image by reflecting the image transferred from the relay optics component; and a light blocker arranged on a rear surface of the combiner and configured to adjust an amount of light flowing into the combiner.

### CROSS-REFERENCE TO RELATED APPLICATION

This application is based on and claims priority under 35 U.S.C. § 119 to Korean Patent Application No. 10-2019-0148084, filed on Nov. 18, 2019, in the Korean Intellectual Property Office, the disclosure of which is incorporated by reference herein in its entirety.

### BACKGROUND

### 1. Field

The disclosure relates to a display apparatus and a display control method.

### 2. Description of Related Art

As an example of a display apparatus, a head up display (HUD) apparatus is well known.

The HUD apparatus may be used for augmented reality (AR), and most optical devices (glass, transparent mirrors, etc.) at the final stage seen by the human eye are manufactured to be transparent. An image generated by the HUD apparatus may be combined with an external landscape viewed through a transparent optical device to generate a meaningful image or the HUD image is viewed while viewing the external landscape.

For example, in a HUD apparatus applied to an existing aircraft or vehicle, a mirror (glass) of the final stage at which a virtual image is generated is manufactured as a transparent or partially light-transmitting optical device through which users may see the surrounding environment (landscape) simultaneously.

### SUMMARY

Provided are a display apparatus with improved image quality and a display control method.

Additional aspects will be set forth in part in the description which follows and, in part, will be apparent from the description, or may be learned by practice of the presented embodiments of the disclosure.

In accordance with an aspect of the disclosure, a display apparatus includes an image source configured to output an image; a relay optics component configured to change a size of the image and to transfer the image; a combiner configured to form a virtual image by reflecting the image transferred from the relay optics component; and a light blocker arranged on a rear surface of the combiner and configured to adjust an amount of light flowing into the combiner.

The image source may include an image panel.

The relay optics component may include a convex mirror configured to magnify and reflect the image output from the image source.

The combiner may include a partially transparent concave mirror.

The light blocker may include a transmittance variable panel having a light transmittance that is controlled electrically, and the display apparatus may further include a processor configured to control the light blocker.

The transmittance variable panel may include at least one of a polymer dispersed liquid crystal (PDLC) panel or a liquid crystal light shutter panel.

The transmittance variable panel may be attached to the rear surface of the combiner.

The processor may be further configured to adjust the light transmittance of the light blocker based on a content attribute of the image output from the image source.

The display apparatus may further include an illuminance sensor, and the processor may be further configured to adjust the light transmittance of the light blocker based on an illuminance detected by the illuminance sensor.

The display apparatus may further include a housing in which the image source, the relay optics component, and the combiner are installed, and the light blocker may include a light shielding plate detachably installed in the housing.

The light shielding plate may be configured to cover the rear surface of the combiner.

The display apparatus may further include a hemispherical transparent cover covering the rear surface of the combiner.

The light shielding plate may be configured to cover the rear surface of the hemispherical transparent cover.

The display apparatus may further include a housing in which the image source, the relay optics component, and the combiner are installed, and the light blocker may include a light shielding plate configured to be contained in a storage space in the housing.

The light blocker may further include a motor configured to move the light shielding plate toward the rear surface of the combiner.

The display apparatus may further include a housing in which the image source, the relay optics component, and the combiner are installed, and the light blocker may include a light shielding film configured to be contained in a storage space in the housing, and a support configured to support the light shielding film.

The light blocker may further include a driving actuator configured to fold the light shielding film.

In accordance with an aspect of the disclosure, a display control method includes outputting an image; transferring the output image by using relay optics; forming a virtual image by reflecting the transferred image using a combiner; and adjusting an amount of light flowing into the combiner using a light blocker arranged on a rear surface of the combiner.

The display control method may further include: detecting a content attribute of the image; and determining a light transmittance of the light blocker based on the content attribute.

The display control method may further include: detecting an illuminance of an external environment; and determining a light transmittance of the light blocker based on the detected illuminance.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram illustrating a display apparatus according to an embodiment;

FIG. 2 is a schematic diagram illustrating an optical system of the display apparatus of FIG. 1 according to an embodiment;

FIG. 3 is a schematic diagram illustrating a configuration of a light blocker according to an embodiment;

FIG. 4 is a diagram illustrating a light transmitting mode of the light blocker of FIG. 3 according to an embodiment;

FIG. 5 is a diagram illustrating a light blocking mode of the light blocker of FIG. 3 according to an embodiment;

FIG. 6 is a schematic diagram illustrating a configuration of a display apparatus according to an embodiment;

FIG. 7 is a schematic diagram illustrating a configuration of a display apparatus according to an embodiment;

FIG. 8 is a schematic diagram illustrating a configuration of a display apparatus according to an embodiment;

FIG. 9 is a schematic diagram illustrating a configuration of a display apparatus according to an embodiment;

FIG. 10 is a schematic diagram illustrating the appearance of a display apparatus according to an embodiment;

FIG. 11 is a schematic diagram illustrating a configuration of a light blocker according to an embodiment;

FIG. 12 is a schematic diagram illustrating a configuration of a light blocker according to an embodiment;

FIG. 13 is a schematic block diagram illustrating a display apparatus according to an embodiment;

FIG. 14 is a schematic block diagram illustrating a display apparatus according to an embodiment;

FIG. 15 is a schematic flowchart illustrating a display control method according to an embodiment;

FIG. 16 is a schematic flowchart illustrating a display control method according to an embodiment; and

FIG. 17 is a schematic flowchart illustrating a display control method according to an embodiment.

### DETAILED DESCRIPTION

Hereinafter, one or more embodiments of the disclosure will be described in detail with reference to accompanying drawings. In the drawings, like reference numerals denote like components, and sizes of components in the drawings may be exaggerated for convenience of explanation. Meanwhile, the embodiments of the disclosure described below are merely exemplary, and various modifications are possible from these embodiments of the disclosure.

Although the terms used the embodiments of the disclosure are selected from among common terms that are currently widely used in consideration of their functions in the disclosure, the terms may vary according the intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

An expression used in the singular encompasses the expression of the plural, unless it has a clearly different meaning in the context. Throughout the specification, when a portion “includes” an element, another element may be further included, rather than excluding the existence of the other element, unless otherwise described.

Throughout the disclosure, the expression “at least one of a, b or c” indicates only a, only b, only c, both a and b, both a and c, both b and c, all of a, b, and c, or variations thereof.

In addition, the terms such as “ . . . unit”, etc. provided in the specification indicates a unit performing at least one function or operation, and may be realized by hardware, software, or a combination of hardware and software.

The expression “configured to (or set to)” used herein may be replaced with, for example, “suitable for,” “having the capacity to,” “designed to,” “adapted to,” “made to,” or “capable of” according to cases. The expression “configured to (or set to)” may not necessarily mean “specifically designed to” in a hardware level. Instead, in some cases, the expression “system configured to . . . ” may mean that the system is “capable of . . . ” along with other devices or parts. For example, “a processor configured to (or set to) perform A, B, and C” may refer to a dedicated processor (e.g., an embedded processor) for performing a corresponding operation, or a general-purpose processor (e.g., a central processing unit (CPU) or an application processor (AP)) capable of performing a corresponding operation by executing one or more software programs stored in a memory.

In the disclosure, the term ‘virtual image’ means a case where light is not actually present on a place where an image is formed by an optical system. In the case of a concave mirror, an erect virtual image is formed when an object is present inside the focal point of the concave mirror. Even when a real image is formed inside the focal point of the concave mirror by another optical system, an image of the real image is formed by the concave mirror.

In the disclosure, the term ‘display apparatus’ is a virtual image display apparatus capable of expressing an image using a virtual image optical system and includes a vehicle head up display (HUD) and an aircraft HUD as well as an indoor and outdoor entertainment HUD.

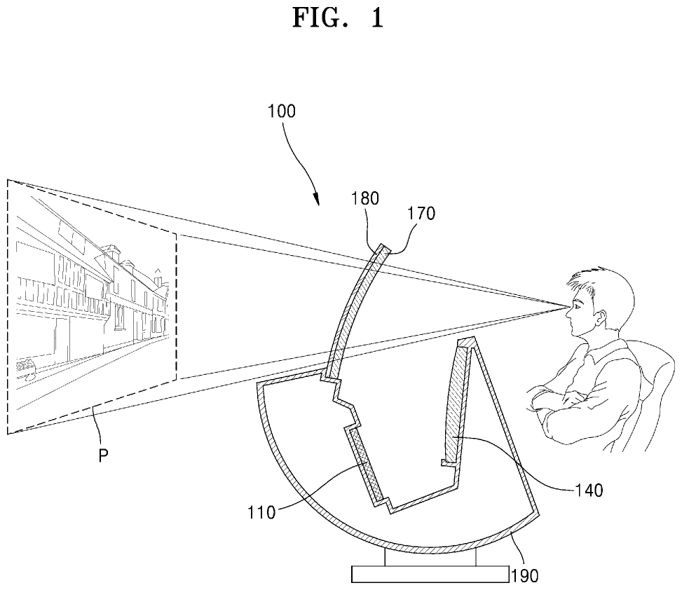

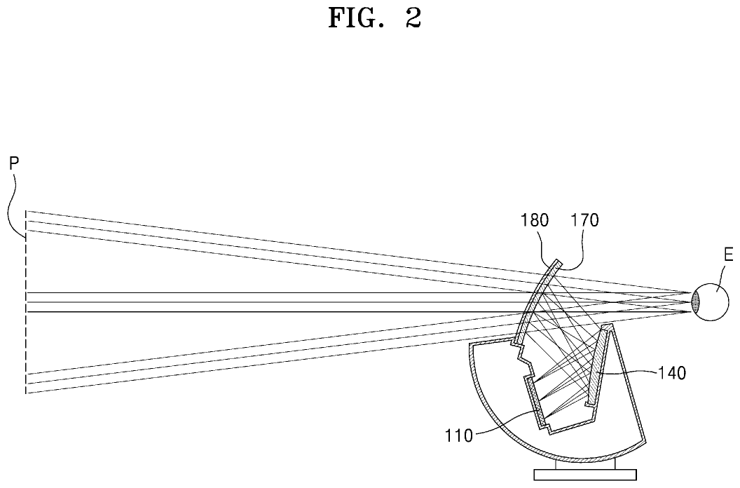

FIG. 1 is a schematic diagram illustrating a display apparatus 100 according to an embodiment of the disclosure, and FIG. 2 is a schematic diagram illustrating an optical system of the display apparatus 100 of FIG. 1.

Referring to FIGS. 1 and 2, the display apparatus 100 includes an image source 110, relay optics 140, a combiner 170, and a light blocker 180. Some of elements of the display apparatus 100 may be integrally combined with the other elements or omitted.

The image source 110 is an apparatus that receives image computer data and outputs an optical image. In an embodiment of the disclosure, the image output from the image source 110 may be a movie, a computer game, a broadcast image, a vehicle navigation image, an aircraft navigation image, etc.

In an embodiment of the disclosure, the image source 110 may include an image panel. The image panel may be, for example, an LCD panel, an OLED panel, an LCoS panel, a DLP panel, etc.

In an embodiment of the disclosure, the image source 110 may be a laser scanning display apparatus. The laser scanning display apparatus may include a laser light source and a scanning apparatus, for example micro-electromechanical system (MEMS) mirror, a rotation polygon mirror, etc., that scans a laser beam emitted from the laser light source.

In an embodiment of the disclosure, the image source 110 may be a cathode ray tube display apparatus.

The relay optics 140 may be optics that change a size of an image, for example by enlarging or reducing an image output from the image source 110 and transfer the image to the combiner 170. The relay optics 140 may include a lens or a plurality of lenses, a mirror or a plurality of mirrors, or a combination thereof.

The relay optics 140 of an embodiment of the disclosure may be a convex mirror that enlarges an image. The convex mirror may be aspherical. The convex mirror may include a glass or plastic material. In the embodiment of the disclosure, the case where one convex mirror is employed as the relay optics 140 is described as an example, but is not limited thereto.

The relay optics 140 of an embodiment of the disclosure may include two or more curved mirrors, a lens or a plurality of lenses, or a combination of at least one lens and at least one mirror.

The combiner 170 is an optical member that forms a virtual image P by reflecting the image transferred from the relay optics 140. In an embodiment of the disclosure, the relay optics 140 and the combiner 170 are arranged such that an object image, for example a formed image, transferred from the relay optics 140 is located inside the focal length of the combiner 170. The combiner 170 may be a partially transparent concave mirror. Here, partial transparency means that part of light is reflected and the other part is transmitted through, and an amount of the transmitted light may vary according to the design and material of a reflective surface of the combiner 170. The reflective surface of the combiner 170 may be aspherical. The combiner 170 may have a curved plate shape. The combiner 170 may include a glass or plastic material. A user E sees the image reflected from the combiner 170 as the virtual image P.

In an embodiment of the disclosure, the relay optics 140 and the combiner 170 may implement a virtual image magnification of 16 times and a virtual image distance of 10 m. For example, when the image surface diameter of the image source 110 is 10, a virtual image size of 160 inches and the virtual image distance of 10 m may be implemented.

The light blocker 180 is an apparatus that is disposed on a rear surface of the combiner 170 to control an amount of light flowing into the combiner 170. In the combiner 170, a surface on which the light transferred from the relay optics 140 is incident will be referred to as a front surface, and the opposite surface of the front surface will be referred to as a rear surface.

In an embodiment of the disclosure, the light blocker 180 may be a transmittance variable panel having a light transmittance that is controlled by electrical control. The transmittance variable panel may be, for example, a polymer dispersed liquid crystal (PDLC) panel or a liquid crystal light shutter panel. The light blocker 180 may have a curved plate shape and may be attached to the rear surface of the combiner 170.

The image source 110, the relay optics 140, the combiner 170, and the light blocker 180 are installed in a housing 190. The image source 110 may be installed on one inner side of the housing 190, and the relay optics 140 may be installed on the other inner side of the housing 190. The combiner 170 and the light blocker 180 may be installed to protrude from the housing 190.

The housing 190 of an embodiment of the disclosure may be installed indoors in the form of a desk top. The user sits on a chair and sees the display apparatus 100 such that the user may have the same experience as sitting in a theater without using virtual reality (VR) glasses.

The housing 190 of an embodiment of the disclosure may be a dashboard of a vehicle or a part of an aircraft cockpit.

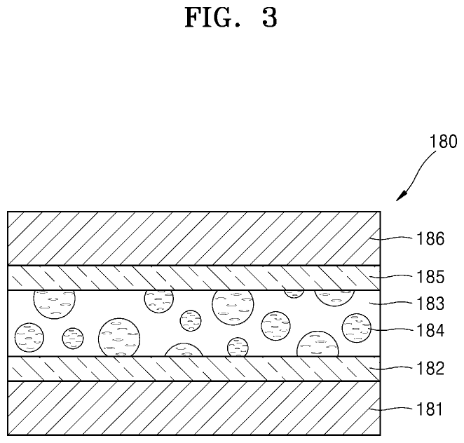

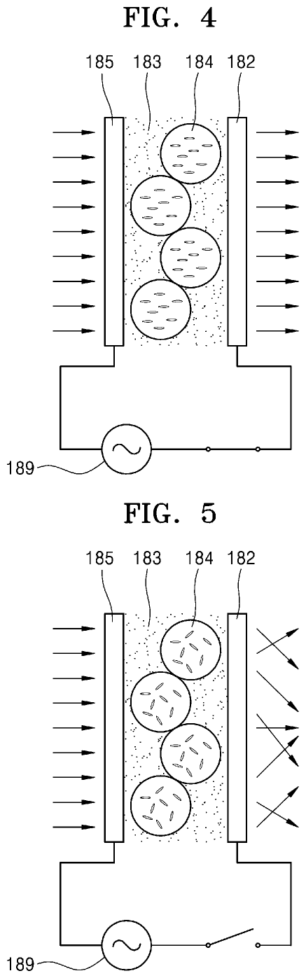

FIG. 3 is a schematic diagram illustrating an example configuration of a light blocker 180 according to an embodiment of the disclosure, FIG. 4 is a diagram illustrating a light transmitting mode of a light blocker 180 of FIG. 3, and FIG. 5 is a diagram illustrating a light blocking mode of a light blocker 180 of FIG. 3.

Referring to FIG. 3, the light blocker 180 may be a PDLC panel. The light blocker 180 has a structure in which a polymer layer 183 in which liquid crystals 184 are dispersed is interposed between two transparent substrates 181 and 186. Transparent electrodes 182 and 185 are provided on inner surfaces of the two transparent substrates 181 and 186, respectively. Each of the transparent substrates 181 and 196 may be, for example, a polymer thin film layer of a transparent material or a glass substrate. The transparent electrodes 182 and 185 may include, for example, transparent conductive polymer material such as indium tin oxide (ITO), fluorine doped tin oxide (FTO), ZnO—Ga₂O₃, ZnO—Al₂O₃, SnO₂—Sb₂O₃, a polythiophene-based material. The light blocker 180 may be manufactured in the form of a flexible film and may be attached to the rear surface of the combiner 170.

While power, for example from voltage source 189, is applied to the light blocker 180, as shown in FIG. 4, a difference in a dielectric constant between the liquid crystals 184 aligned according to the electric field and polymer is reduced such that the polymer layer 183 becomes transparent and is in a transparent state in which light is emitted. The transparency of the polymer layer 183 may be adjusted by adjusting the intensity of the power (voltage) applied to the light blocker 180. While the power is not applied, the polymer layer 183 is in a scattering state in which incident light is scattered due to the difference in the dielectric constant between the polymer and the liquid crystals 184 and thus the transparency is significantly lowered.

As described above, the light blocker 180 with adjustable transparency is used, thereby actively adjusting an amount of external light flowing into the combiner 170.

For example, when a user watches a movie or plays a computer game by using the display apparatus 100 of the embodiment of the disclosure, the transparency of the light blocker 180 is significantly reduced, and thus the influence of the surrounding environment, for example external light, to a minimum may be reduced, thereby improving the immersion of the user. In addition, even when it is unnecessary to view the surrounding environment at the same time, unnecessary surrounding environment, for example external light, is blocked or reduced to the minimum, thereby improving the visibility of the image.

When it is necessary to view the surrounding environment at the same time, the transparency of the light blocker 180 may be increased or appropriately adjusted to allow the user to view surrounding objects together with the virtual image.

In the embodiment of the disclosure, the PDLC panel is described as an example of the light blocker 180 with a variable transmittance, but a liquid crystal optical shutter panel may be employed. The liquid crystal optical shutter panel has a structure in which a liquid crystal panel is interposed between polarizing plates orthogonal to each other. The liquid crystal panel has a structure in which a liquid crystal layer is interposed between two transparent substrates. Transparent electrodes are provided on the inner surfaces of the two transparent substrates, respectively. Various methods, such as twisted nematic (TN), vertical alignment (VA), plane to line switching (PLS), etc. are known with respect to the liquid crystal panel according to an alignment method of liquid crystals and the arrangement of transparent electrodes. For example, in the case of the TN, liquid crystal molecules are oriented in a twisted state by 90 degrees while no power is applied, and when the power is applied, the liquid crystal molecules rotate along the direction of the electric field and are untwisted. Therefore, when no voltage is applied to electrodes (that is, in an off state), light of linear polarization incident on a TN liquid crystal layer passes through the liquid crystal panel because of rotation of a polarization direction. Because a degree of rotation of the liquid crystal molecules may be adjusted according to the intensity of the power (i.e., voltage), the transmittance of the liquid crystal panel may be adjusted. Meanwhile, when the voltage is applied to the transparent electrodes (that is, in an on state), because the light of linear polarization incident on the TN liquid crystal layer maintains polarization, the light does not pass through the liquid crystal panel.

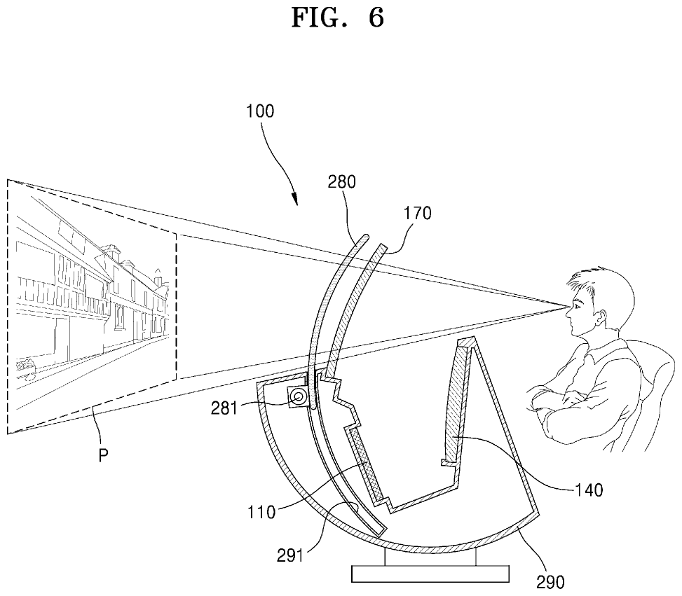

FIG. 6 is a schematic diagram illustrating a configuration of the display apparatus 100 according to an embodiment of the disclosure.

Referring to FIG. 6, the display apparatus 100 of the embodiment of the disclosure includes the image source 110, the relay optics 140, the combiner 170, and a light blocker 280. Some of elements of the display apparatus 100 may be integrally combined with the other elements or omitted.

The display apparatus 100 of the embodiment of the disclosure is substantially the same as the display apparatus 100 of the embodiment of the disclosure described with reference to FIGS. 1 to 5, except that a light shielding plate is used as the light blocker 280 instead of a transmittance variable panel, and thus differences will be mainly described.

The light blocker 280 may be an opaque plate material disposed on the rear surface of the combiner 170 to block light flowing into the rear surface of the combiner 170.

A storage 291 in which the light blocker 280 is contained may be provided in a housing 290 in which the image source 110, the relay optics 140, and the combiner 170 are installed. A motor 281 that provides driving force to automatically pull or withdraw the light blocker 280 to or from the storage 291 may be connected to a lower end of the light blocker 280. The light blocker 280 may be automatically withdrawn from the storage 291 by manipulation of the user and located to cover the rear surface of the combiner 170.

When the user does not need to watch a movie, play a computer game, or watch the surrounding environment simultaneously by using the display apparatus 100 of the embodiment of the disclosure, the light blocker 280 is disposed on the rear surface of the combiner 170 such that the user may see only a virtual image displayed by the display apparatus 100 without seeing the surrounding environment, thereby providing immersion to the user and improving the visibility of the image.

When it is necessary to view the surrounding environment at the same time, the light blocker 280 is inserted into the storage 291 of the housing 290 to allow the user to view surrounding objects together with the virtual image.

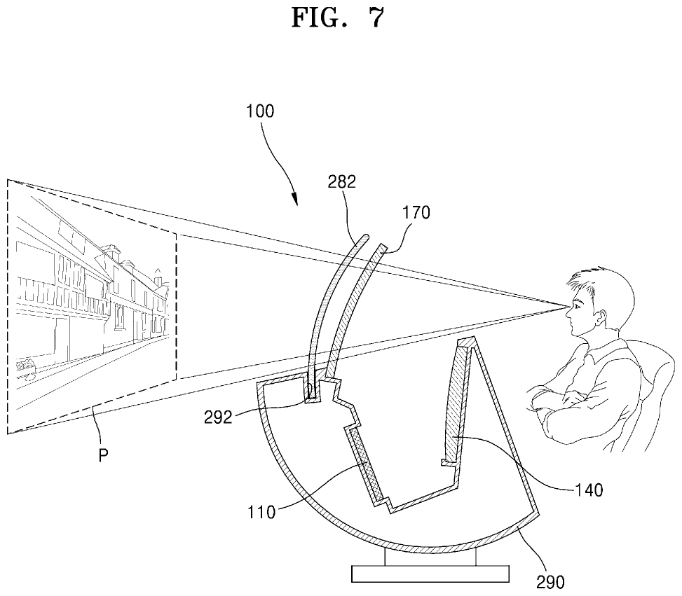

FIG. 7 is a schematic diagram illustrating a configuration of the display apparatus 100 according to an embodiment of the disclosure.

Referring to FIG. 7, the display apparatus 100 of the embodiment of the disclosure includes the image source 110, the relay optics 140, the combiner 170, and a light blocker 282. Some of elements of the display apparatus 100 may be integrally combined with the other elements or omitted.

The display apparatus 100 of the embodiment of the disclosure is substantially the same as the display apparatus 100 of the embodiment of the disclosure described with reference to FIG. 6, except that the light blocker 282 may be a light shielding plate detachably coupled to the housing 290, and thus differences will be mainly described.

A coupler 292 is provided on one side of the housing 290 so as to be detachably coupled to one side of the light blocker 282. The light blocker 282 is detachably coupled to the coupler 292 of the housing 290, and the light blocker 282 is located on the rear surface of the combiner 170. A user directly couples the light blocker 282 to the coupler 292 of the housing 290, and thus light flowing into the rear surface of the combiner 170 may be blocked. The light blocker 282 is detached from the coupler 292 of the housing 290 to allow the user to view surrounding objects together with the virtual image.

The light blocker 282 may be an opaque member that completely blocks light, but is not limited thereto. As the light blocker 282, not only the opaque member, but also a partially transparent member with a preset transmittance may be provided. For example, as the light blocker 282, a translucent member with a transmittance of 10%, 20%, or 30% is provided such that the user may selectively use the translucent member according to the purpose of use.

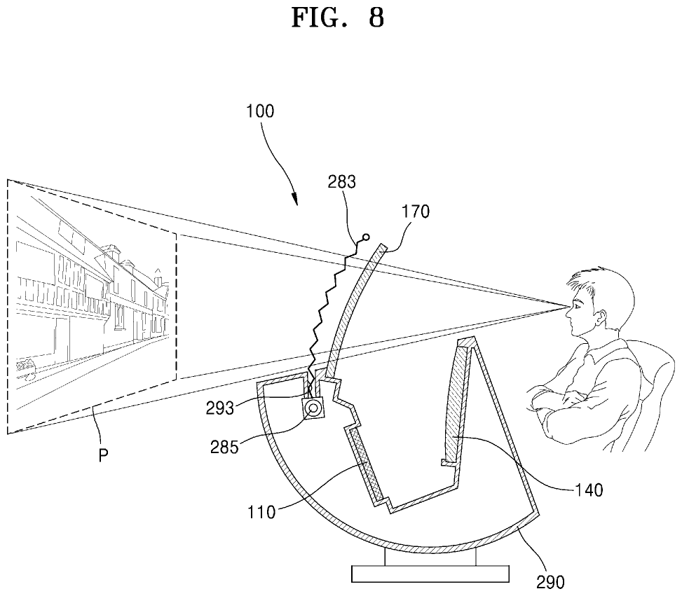

FIG. 8 is a schematic diagram illustrating a configuration of the display apparatus 100 according to an embodiment of the disclosure.

Referring to FIG. 8, the display apparatus 100 of the embodiment of the disclosure includes the image source 110, the relay optics 140, the combiner 170, and a light blocker 283. Some of elements of the display apparatus 100 may be integrally combined with the other elements or omitted.

The display apparatus 100 of the embodiment of the disclosure is substantially the same as the display apparatus 100 of the embodiment of the disclosure described with reference to FIGS. 1 to 7, except that a light shielding film is used as the light blocker 283, and thus differences will be mainly described.

In an embodiment of the disclosure, the light blocker 283 may be an opaque blackout curtain. The blackout curtain may be supported by a support.

In an embodiment of the disclosure, the light blocker 283 may be configured as foldable plates of an opaque material.

The light blocker 283 is connected to an actuator 285 and may be automatically folded or unfolded. The actuator 285 may be driven by the manipulation of a user. A storage 293 in which the folded light blocker 283 is contained may be provided in the housing 290. The unfolded light blocker 283 is configured to cover the rear surface of the combiner 170.

Although the display apparatus 100 of the embodiment of the disclosure is described by way of an example in which the light blocker 283 is automatically opened and closed by the actuator 285, the actuator 285 may be omitted, and in this case, the light blocker 283 may be manually opened and closed.

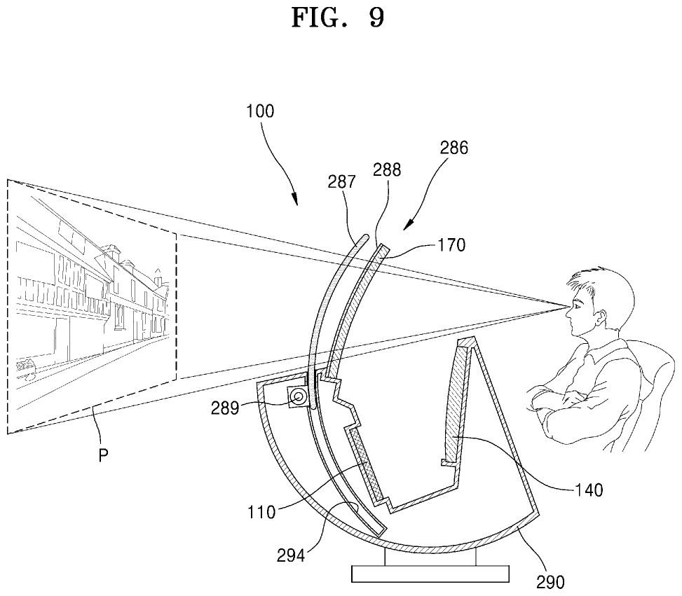

FIG. 9 is a schematic diagram illustrating a configuration of the display apparatus 100 according to an embodiment of the disclosure.

Referring to FIG. 9, the display apparatus 100 of the embodiment of the disclosure includes the image source 110, the relay optics 140, the combiner 170, and a light blocker 286. Some of elements of the display apparatus 100 may be integrally combined with the other elements or omitted.

The display apparatus 100 of the embodiment of the disclosure is substantially the same as the display apparatus 100 of the embodiment of the disclosure described with reference to FIGS. 1 to 7, except that first and second polarizing plates 287 and 288 are used as the light blocker 286, and thus differences will be mainly described.

The light blocker 286 includes the first and second polarizing plates 287 and 288. Each of the first and second polarizing plates 287 and 288 is an optical member that passes only a linear polarization component (e.g., P polarization or S polarization) in one direction among components of incident light. An actuator 289 that provides driving force to automatically pull or withdraw the first polarizing plate 287 to or from the storage 294 may be connected to the first polarizing plate 287. The actuator 289 may be driven by the manipulation of a user. The second polarizing plate 288 is fixed to the rear surface of the combiner 170. The second polarizing plate 288 may be attached to the rear surface of the combiner 170.

In an embodiment of the disclosure, the actuator 289 moves the first polarizing plate 287 in one direction. The first polarizing plate 287 and the second polarizing plate 288 may be arranged such that linear polarization components of light passing therethrough are orthogonal to each other. The first polarizing plate 287 may be automatically withdrawn from the storage 294 by the manipulation of the user and located to overlap the second polarizing plate 288 on the rear surface of the combiner 170. When the first polarizing plate 287 and the second polarizing plate 288 overlap, because polarization directions are orthogonal to each other, external light is blocked by the first and second polarizing plates 287 and 288.

In an embodiment of the disclosure, the actuator 289 may be configured to not only move the first polarizing plate 287 in one direction, but also rotate the first polarizing plate 287 such that the polarization directions change. The first polarizing plate 287 may be automatically withdrawn from the storage 294 by the manipulation of the user and located to overlap the second polarizing plate 288 on the rear surface of the combiner 170. Furthermore, the polarization direction of the first polarizing plate 287 and the polarization direction of the second polarizing plate 288 may change as the first polarizing plate 287 rotates by the driving of the actuator 289. When the first polarizing plate 287 and the second polarizing plate 288 overlap, an amount of external light passing through the first and second polarizing plates 287 and 288 may be adjusted according to the polarizing direction of the first polarizing plate 287 and the polarizing direction of the second polarizing plate 288. For example, when the polarization direction of the first polarizing plate 287 and the polarization direction of the second polarizing plate 288 are orthogonal, the external light is blocked. As another example, when the polarization direction of the first polarizing plate 287 and the polarization direction of the second polarizing plate 288 are equal to each other, the external light is only lost due to polarization filtering of the first and second polarizing plates 287 and 288.

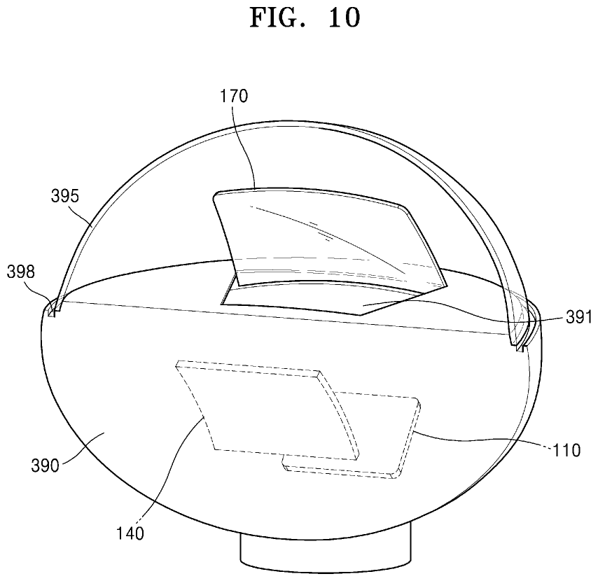

FIG. 10 is a schematic diagram illustrating the appearance of the display apparatus 100 according to an embodiment of the disclosure.

Referring to FIG. 10, the display apparatus 100 of the embodiment of the disclosure includes the image source 110, the relay optics 140, the combiner 170, a housing 390, and a transparent cover 395. A light blocker 380 or light blocker 381, examples of which will be described later, may be mounted on the display apparatus 100. Some of elements of the display apparatus 100 may be integrally combined with the other elements or omitted.

The display apparatus 100 of the embodiment of the disclosure is substantially the same as the display apparatus 100 of the embodiment of the disclosure described with reference to FIGS. 1 to 9, except for the light blocker 380 or 381 and the transparent cover 395, and thus differences will be mainly described.

The image source 110 may be installed on one side of the housing 390, and the relay optics 140 may be installed on the inner side of the housing 390. An image output from the image source 110 is directed to the relay optics 140. The combiner 170 may be installed to protrude from an upper end of the housing 390. An opening 391 is provided in the upper end of the housing 390 such that light transferred from the relay optics 140 may be directed to the combiner 170 through the opening 391. The hemispherical transparent cover 395 is installed on the upper end of the housing 390. The hemispherical transparent cover 395 covers the rear surface of the combiner 170 protruding from the upper end of the housing 390. The transparent cover 395 protects an optical system of the display apparatus 100 including the combiner 170. The transparent cover 395 may be formed to a size that sufficiently covers the user's field of view to increase the immersion of a user. A coupling groove 398 in which the light blocker 380 to be described later may be installed may be provided on an upper outer side of the housing 390.

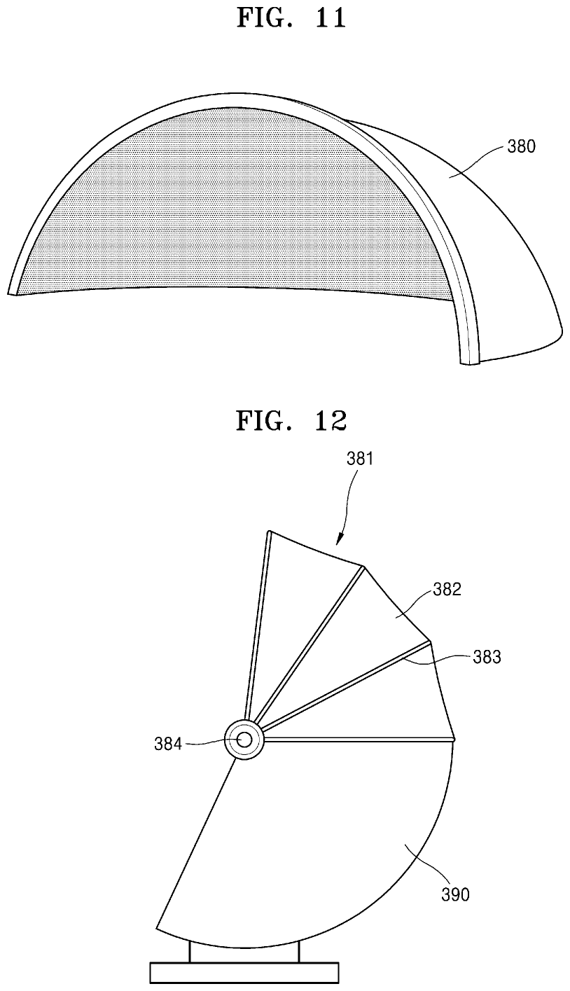

FIG. 11 is a schematic diagram illustrating the configuration of the light blocker 380 according to an embodiment of the disclosure. Referring to FIG. 11, the light blocker 380 may have an opaque hemispherical shape. The light blocker 380 of the embodiment of the disclosure may be mounted on the display apparatus 100 of FIG. 10. That is, the light blocker 380 may be detachably installed in the housing 390 to cover an outer surface of the transparent cover 395. When the light blocker 380 is coupled to the coupling groove 398 of the housing 390, a user may not see an outer scene but may see only a virtual image formed on the combiner 170. When it is necessary to view the surrounding environment at the same time, the light blocker 380 may be detached from the housing 390 to allow the user to view surrounding objects together with the virtual image.

FIG. 12 is a schematic diagram illustrating the configuration of the light blocker 381 according to an embodiment of the disclosure. Referring to FIG. 12, the light blocker 381 may include a foldable sunshade 382 to cover an outer surface of the transparent cover 395 and a support 383 supporting the sunshade 382. The light blocker 381 of the embodiment of the disclosure may replace the light blocker 380 of FIG. 11 and be mounted on the display apparatus 100 of FIG. 10. The support 383 rotates with respect to a rotation shaft 384 such that the sunshade 382 covers or folds the outer surface of the transparent cover 395. The light blocker 381 may be fixed to or installed detachably in the housing 390. When the light blocker 381 covers the outer surface of the transparent cover 395, a user may not see an outer scene but may see only a virtual image formed on the combiner 170. When it is necessary to view the surrounding environment at the same time, the light blocker 381 may be folded to allow the user to view surrounding objects together with the virtual image. Although the light blocker 381 of the embodiment of the disclosure is manually opened or closed, the light blocker 381 may be automatically opened or closed by providing an actuator (not shown).

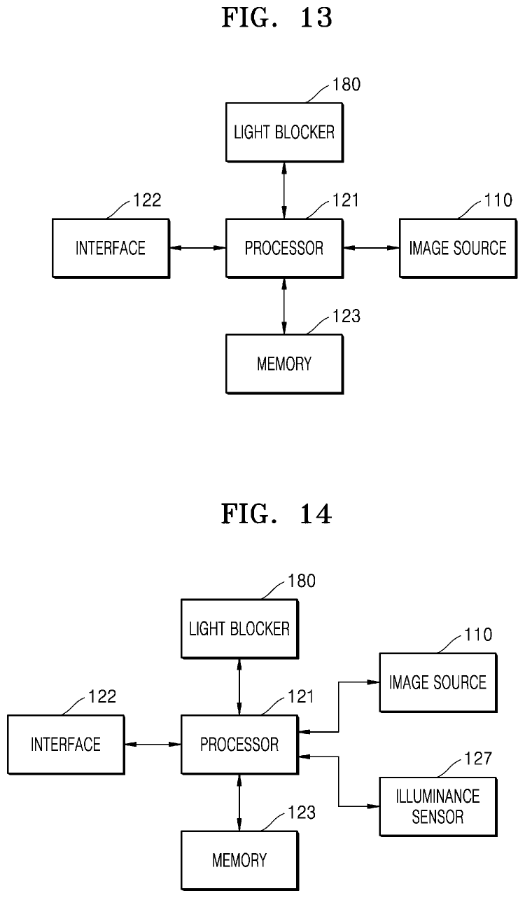

FIG. 13 is a schematic block diagram illustrating the display apparatus 100 according to an embodiment of the disclosure.

Referring to FIG. 13, the display apparatus 100 includes the image source 110, the light blocker 180, a processor 121, an interface 122, and a memory 123.

The processor 121 may control an overall operation of the display apparatus 100 including the image source 110 and the light blocker 180 by driving an operating system or an application program, and may perform processing and operations on various data including image data. For example, the processor 121 may process image data such as a movie. For example, the processor 121 may drive a program such as a computer game. For example, the processor 121 may drive a program such as navigation. As an example, the processor 121 may drive various simulator programs such as a vehicle, an aircraft, a ship, a mechanical device, etc. The processor 121 may be configured as at least one hardware of, for example, a central processing unit, a microprocessor, a graphic processing unit, application specific integrated circuits (ASICs), digital signal processors (DSPs), digital signal processing devices (DSPDs), programmable logic devices (PLDs), or field programmable gate arrays (FPGAs), but is not limited thereto.

The interface 122 is to input/output of data or manipulation commands from the outside, and may include, for example, a user interface such as a touch pad, a controller, an operation button, and a keyboard that are operable by a user. In an embodiment of the disclosure, the interface 122 includes a wired communication module, such as a USB module, a LAN module, or a wireless communication module, such as Bluetooth, and may receive user manipulation information or image data transferred from an external device or network through the communication modules.

The memory 123 may include internal memory such as volatile memory or nonvolatile memory. The memory 123 may store various data, programs or applications that drive and control the display apparatus 100 under the control of the processor 121, and input/output signal or image data.

The image source 110 is configured to receive the image data generated by the processor 121 and generate light of a 2D image, and may be an image panel such as an LCD panel, an OLED panel, an LCoS panel, or a DLP panel, a laser scanning display apparatus or a cathode ray tube display apparatus.

The light blocker 180 is an apparatus that adjusts an amount of light flowing into the combiner, for example combiner 170 in FIG. 1, and may be controlled by the control commands transferred from the processor 121. As described in the above-described embodiments of the disclosure, the light blocker 180 may be a transmittance variable panel of which transmittance is controlled by electrical control, but may be a light shielding plate or a light shielding film that is automatically opened and closed.

The processor 121 may adjust the transmittance of the light blocker 180 based on a content attribute of the image output from the image source 110.

FIG. 14 is a schematic block diagram illustrating the display apparatus 100 according to an embodiment of the disclosure.

Referring to FIG. 14, the display apparatus 100 may further include an illuminance sensor 127 together with the image source 110, the light blocker 180, the processor 121, the interface 122, and the memory 123.

The illuminance sensor 127 is a sensor that detects the illuminance of the surrounding environment. Illuminance information obtained from the illuminance sensor 127 may be transferred to the processor 121 to control the light blocker 180 based on the illuminance of the surrounding environment.

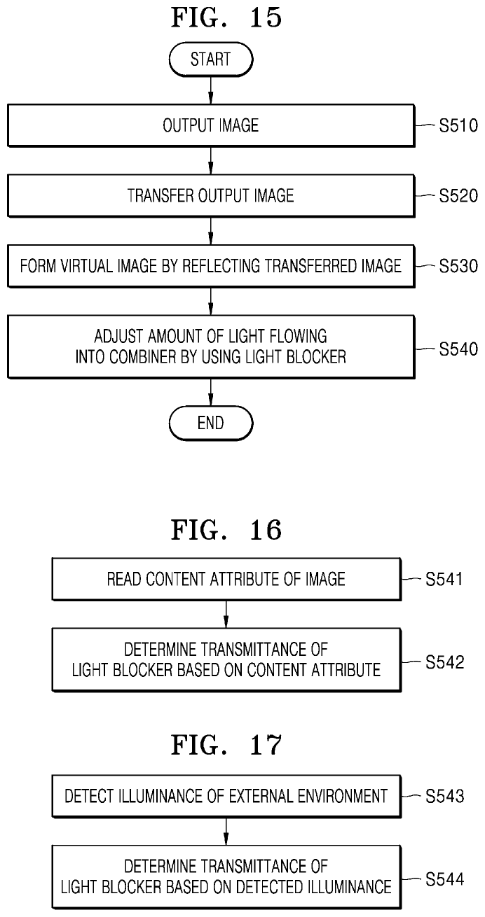

FIG. 15 is a schematic flowchart illustrating a display control method according to an embodiment of the disclosure.

Referring to FIG. 15, a display apparatus according to an embodiment of the disclosure allows the processor 121 to process data received through the interface 122 or stored in the memory 123 and the image source 110 to output an image at operation S510. The output image is enlarged or reduced through the relay optics 140 and transferred to the combiner 170 at operation S520. The combiner 170 reflects the received image to form a virtual image at operation S530. Meanwhile, an amount of external light flowing into the combiner 170 is controlled by using the light blocker 180 at operation S540. Here, adjusting the amount of the external light flowing into the combiner 170 includes not only making only part of the external light transmitted but also blocking the external light or making the external light completely transmitted. When the light blocker 180 is a transmittance variable panel, only part of the external light may be transmitted, but when the light blocker 180 is a light shielding plate or a light shielding film, the external light will be blocked or transmitted.

FIG. 16 is a schematic flowchart illustrating a display control method according to an embodiment of the disclosure. Referring to FIG. 16, operation S540 of adjusting an amount of external light may include operation S541 in which the processor 121 reads a content attribute of an image, and operation S542 in which the processor 121 determines transmittance of the light blocker 180 based on the content attribute. A user may directly determine the transmittance of the light blocker 180.

In an embodiment of the disclosure, when the user wants to see a virtual image along with the surrounding environment or sees AR-related content, the user may make the light blocker 180 transparent.

In an embodiment of the disclosure, when the user wants to immerse in the virtual image without seeing the surrounding environment, the user may make the light blocker 180 opaque. In this case, the user may see only the virtual image through the combiner 170 and may not see the environment, for example a landscape, outside the combiner 170.

In an embodiment of the disclosure, when the user wants to see the surrounding environment together, but wants to increase the quality or visibility, etc., of the virtual image, the user may appropriately adjust the transparency or reflectivity of the light blocker.

FIG. 17 is a schematic flowchart illustrating a display control method according to an embodiment of the disclosure.

Referring to FIG. 17, operation at S540 of adjusting an amount of external light may include operation S543 in which the processor 121 allows the illuminance sensor, for example illuminance sensor 127 in FIG. 14, to detect the illuminance of the surrounding environment, and operation S544 in which the processor 121 determines transmittance of the light blocker 180 based on the detected illuminance.

In an embodiment of the disclosure, when the surrounding environment is dark, the processor 121 increases the transmittance of the light blocker 180 such that the surrounding environment may be better seen.

In an embodiment of the disclosure, when the surrounding environment is bright, the processor 121 lowers the transmittance of the light blocker 180 such that the visibility of a virtual image may increase.

Although the display apparatus 100 described in the disclosure is described as a desktop-top type, those of ordinary skill in the art may clearly understand that the display apparatus 100 may be modified as a vehicle HUD or an aircraft HUD.

According to the disclosure, the display apparatus and the display control method may improve the image quality performance of a virtual image in accordance with the purpose in accordance with the attributes of content.

According to the disclosure, the display apparatus and the display control method may improve the immersion of the user in accordance with the attributes of content.

While the display apparatus and the display control method have been particularly shown and described with reference to exemplary embodiments thereof, it will be understood by those of ordinary skill in the art that various changes in form and details may be made therein without departing from the spirit and scope as defined by the following claims. Therefore, the scope sought to be protected of the disclosure shall be defined by the appended claims.

What is claimed is:

1. A display apparatus comprising:
an image source configured to output an image;
a relay optics component configured to change a size of the image and to transfer the image;
a combiner configured to form a virtual image by reflecting the image transferred from the relay optics component; and
a light blocker arranged on a rear surface of the combiner and configured to adjust an amount of light flowing into the combiner.

2. The display apparatus of claim 1, wherein the image source comprises an image panel.

3. The display apparatus of claim 1, wherein the relay optics component comprises a convex mirror configured to magnify and reflect the image output from the image source.

4. The display apparatus of claim 1, wherein the combiner comprises a partially transparent concave mirror.

5. The display apparatus of claim 1, wherein the light blocker comprises a transmittance variable panel having a light transmittance that is controlled electrically, and
wherein the display apparatus further comprises a processor configured to control the light blocker.

6. The display apparatus of claim 5, wherein the transmittance variable panel comprises at least one of a polymer dispersed liquid crystal (PDLC) panel or a liquid crystal light shutter panel.

7. The display apparatus of claim 5, wherein the transmittance variable panel is attached to the rear surface of the combiner.

8. The display apparatus of claim 5, wherein the processor is further configured to adjust the light transmittance of the light blocker based on a content attribute of the image output from the image source.

9. The display apparatus of claim 5, further comprising an illuminance sensor,
wherein the processor is further configured to adjust the light transmittance of the light blocker based on an illuminance detected by the illuminance sensor.

10. The display apparatus of claim 1, further comprising a housing in which the image source, the relay optics component, and the combiner are installed,
wherein the light blocker comprises a light shielding plate detachably installed in the housing.

11. The display apparatus of claim 10, wherein the light shielding plate is configured to cover the rear surface of the combiner.

12. The display apparatus of claim 10, further comprising a hemispherical transparent cover covering the rear surface of the combiner.

13. The display apparatus of claim 12, wherein the light shielding plate is configured to cover the rear surface of the hemispherical transparent cover.

14. The display apparatus of claim 1, further comprising a housing in which the image source, the relay optics component, and the combiner are installed,
wherein the light blocker comprises a light shielding plate configured to be contained in a storage space in the housing.

15. The display apparatus of claim 14, wherein the light blocker further comprises a motor configured to move the light shielding plate toward the rear surface of the combiner.

16. The display apparatus of claim 1, further comprising a housing in which the image source, the relay optics component, and the combiner are installed,
wherein the light blocker comprises a light shielding film configured to be contained in a storage space in the housing, and a support configured to support the light shielding film.

17. The display apparatus of claim 16, wherein the light blocker further comprises a driving actuator configured to fold the light shielding film.

18. A display control method comprising:
outputting an image;
transferring the output image by using relay optics;
forming a virtual image by reflecting the transferred image using a combiner; and
adjusting an amount of light flowing into the combiner using a light blocker arranged on a rear surface of the combiner.

19. The display control method of claim 18, further comprising:
detecting a content attribute of the image; and
determining a light transmittance of the light blocker based on the content attribute.

20. The display control method of claim 18, further comprising:
detecting an illuminance of an external environment; and
determining a light transmittance of the light blocker based on the detected illuminance.
